(19) United States
(12) Patent Application Publication
(10) Pub. No.: US 2012/0307034 A1
(43) Pub. Date: Dec. 6, 2012

(54) IMAGE PROCESSING APPARATUS, IMAGE PROCESSING METHOD, AND ELECTRONIC APPARATUS

(75) Inventor: Taketoshi Sekine, Shizuoka (JP)

(73) Assignee: SONY CORPORATION, Tokyo (JP)

(21) Appl. No.: 13/574,536

(22) PCT Filed: Jan. 19, 2011
(86) PCT No.: PCT/JP2011/000265

§ 371 Date: Jul. 20, 2012

(30) Foreign Application Priority Data
Jan. 29, 2010 (JP) 2010-018287
Jul. 13, 2010 (JP) 2010-158867

(51) Int. Cl. G06K 9/46; H04N 7/18

(52) U.S. Cl. 348/77; 382/190; 348/E07.085

(57) ABSTRACT

To propose, in a skin detecting technique using light having a plurality of different wavelengths, an optimum spectral characteristic of an optical filter and optimum wavelengths lambda1, lambda2 of irradiation Detection subject light for preventing external light from entering an imaging section, provided is an image processing apparatus to detect a skin region representing a human skin from an image. The apparatus includes: a first irradiator; a second irradiator; an incident light limiter; a generator to generate a first image and a second image on the basis of the reflected light which enters from the subject through the incident light limiter; and a detector to detect the skin region on the basis of the first image and the second image.

### TECHNICAL FIELD

The present invention relates to an image processing apparatus, an image processing method, and an electronic apparatus, and in particular, to an image processing apparatus, an image processing method, and an electronic apparatus by which an exposed portion of a human body such as a hand can be detected on the basis of a taken image.

### BACKGROUND ART

There exists a skin detecting technique for detecting a region in which a skin is exposed such as a face and a hand (hereinafter referred to as “skin region”) from an image which can be acquired by imaging a human figure (see, for example, Patent Literature 1).

According to this skin detecting technique, there are acquired a first image acquired by imaging a subject (human figure) in a state where the subject is irradiated with an LED (Light Emitting Diode) to emit light having a wavelength lambda1 and a second image acquired by imaging the subject in a state where the subject is irradiated with another LED to emit light having a wavelength lambda2 which is different from the wavelength lambda1. Then, a region in which a difference in luminance between the first image and the second image is larger than a specified threshold value is detected as a skin region.

In this regard, the wavelengths lambda1, lambda2 are determined depending on the reflection characteristics of a human skin. In other words, the wavelengths lambda1, lambda2 are determined in such a way that the reflectance of the human skin when the human skin is irradiated with light having the wavelength lambda1 is different from the reflectance of the human skin when the human skin is irradiated with light having the wavelength lambda2 and that the reflectance of a subject other than the human skin (for example, hair or cloths) when the subject is irradiated with light having the wavelengths lambda1 is nearly equal to the reflectance of the subject when the subject is irradiated with light having the wavelength lambda2. Specifically, the wavelength lambda1 is determined to be, for example, 870 nm and the wavelength lambda2 are determined to be, for example, 950 nm.

As described above, according to the skin detecting technique in the past, the difference in luminance between the first image of the subject in a state in which the subject is irradiated with the light having the wavelength lambda1 and the second image of the subject in a state in which the subject is irradiated with the light having the wavelength lambda2 is calculated, so that when a pixel value of the first image and a pixel value of the second image are saturated by the effect of external light other than the LED of an irradiation light source, the difference cannot be calculated. Thus, according to the skin detecting technique in the past, the incidence of the external light is limited so as to prevent the external light from affecting the first image and the second image, and an optical filter through which the light having the wavelength lambda1 and the light having the wavelength lambda2 are transmitted is provided in front of an imaging section made of a collective lens, an imaging element, and the like.

The spectral characteristic of this optical filter needs to be changed depending on the wavelengths lambda1, lambda2, and when the spectral characteristic of the optical filter is changed, the first image and the second image have the effect of the changed spectral characteristic, which results in causing a change also in the luminance of both images. If the luminances of the first and the second images are decreased, the gain of luminance amplification by the imaging section can be increased, and when the gain of luminance amplification can be increased, the quantity of light of the LED can be decreased.

### Citation List

### Patent Literature

### PTL 1: Japanese Patent Application Laid-open No. 2006-47067

### SUMMARY OF INVENTION

As described above, the spectral characteristic of an optical filter correlates with the wavelengths lambda1, lambda2 of an LED, the gain of luminance amplification, the quantity of light of the LED, so that it is difficult to uniquely determine the optimum spectral characteristic of the optical filter.

Actually, in the skin detecting technique in the past, it is proposed to provide an optical filter but it is only described that the optical filter should interrupt visible light and transmit light having a wavelength lambda1 and light having a wavelength lambda2. There is no description of the optimum spectral characteristic of the optical filter.

The present invention has been made in view of these circumstances. In a skin detecting technique using light having a plurality of different wavelengths, the present invention proposes the optimum spectral characteristic of an optical filter and the optimum wavelengths lambda1, lambda2 of irradiation light for preventing external light from entering an imaging section and intends to suppress the output of an irradiation light source by providing the optical filter and the irradiation light source.

According to a first embodiment of the present invention, there is provided an image processing apparatus to detect a skin region representing a human skin from an image. The apparatus includes: a first irradiation means for irradiating a subject with light having a first wavelength; a second irradiation means for irradiating the subject with light having a second wavelength longer than the first wavelength; an incident light limiting means for defining a third wavelength shorter than the first wavelength as a reference, for absorbing light having a wavelength shorter than the third wavelength, and for transmitting light having a wavelength longer than the third wavelength; a generating means for generating a first image on the basis of reflected light which enters from the subject through the incident light limiting means when the subject is irradiated with the light having the first wavelength and for generating a second image on the basis of the reflected light which enters from the subject through the incident light limiting means when the subject is irradiated with the light having the second wavelength; and a detecting means for detecting the skin region on the basis of the first image and the second image.

It is possible to make the first wavelength lambda1, the second wavelength lambda2, and the third wavelength lambdacut satisfy the following expressions,

λ1−70 nm≦λcut≦λ1−30 nm

λ1+40 nm<λ2

It is possible to cause the first wavelength lambda1 and the second wavelength lambda2 to satisfy the following expressions,

800 nm<λ1<1000 nm

900 nm<λ2<1100 nm

According to the first embodiment of the present invention, there is also provided an image processing method for an image processing apparatus. The image processing apparatus includes a first irradiation means for irradiating a subject with light having a first wavelength, a second irradiation means for irradiating the subject with light having a second wavelength longer than the first wavelength, an incident light limiting means for defining a third wavelength shorter than the first wavelength as a reference, for absorbing light having a wavelength shorter than the third wavelength, and for transmitting light having a wavelength longer than the third wavelength, a generating means for generating an image on the basis of reflected light which enters from the subject, and a detecting means for detecting the skin region on the basis of the generated images. The image processing method includes: a first irradiation step of irradiating the subject with the light having the first wavelength by the first irradiation means; a first generating step of generating a first image by the generating means on the basis of the reflected light that enters from the subject through the incident light limiting means when the subject is irradiated with the light having the first wavelength; a second irradiation step of irradiating the subject with the light having the second wavelength by the second irradiation means; a second generating step of generating a second image by the generating means on the basis of the reflected light that enters from the subject through the incident light limiting means when the subject is irradiated with the light having the second wavelength; and a detection step of detecting the skin region on the basis of the first image and the second image by the detecting means.

According to the first embodiment of the present invention, there is also provided an image processing apparatus to detect a skin region representing a human skin from an image. The apparatus includes a first irradiator, a second irradiator, an incident light limiter, a generator, and a detector. The first irradiator irradiates a subject with light having a first wavelength. The second irradiator irradiates the subject with light having a second wavelength longer than the first wavelength. The incident light limiter defines a third wavelength shorter than the first wavelength as a reference, absorbs light having a wavelength shorter than the third wavelength, and transmits light having a wavelength longer than the third wavelength. The generator generates a first image on the basis of reflected light which enters from the subject through the incident light limiter when the subject is irradiated with the light having the first wavelength, and generates a second image on the basis of the reflected light which enters from the subject through the incident light limiter when the subject is irradiated with the light having the second wavelength. The detector detects the skin region on the basis of the first image and the second image.

In the first embodiment of the present invention, the first image is generated on the basis of the reflected light that enters from the subject through the incident light limiting means, and the second image is generated on the basis of the reflected light that enters from the subject through the incident light limiting means when the subject is irradiated with the light having the second wavelength. The skin region is detected on the basis of the first image and the second image.

According to a second embodiment of the present invention, there is provided an electronic apparatus including: a first irradiation means for irradiating a subject with light having a first wavelength; a second irradiation means for irradiating the subject with light having a second wavelength longer than the first wavelength; an incident light limiting means for defining a third wavelength shorter than the first wavelength as a reference, for absorbing light having a wavelength shorter than the third wavelength, and for transmitting light having a wavelength longer than the third wavelength; a generating means for generating a first image on the basis of reflected light which enters from the subject through the incident light limiting means when the subject is irradiated with the light having the first wavelength and for generating a second image on the basis of the reflected light which enters from the subject through the incident light limiting means when the subject is irradiated with the light having the second wavelength; a detecting means for detecting the skin region on the basis of the first image and the second image; and an operation controlling means for performing a specified processing in response to a change in the detected skin region.

According to the second embodiment of the present invention, there is also provided an electronic apparatus. The electronic apparatus includes a first irradiator, a second irradiator, an incident light limiter, a generator, a detector, and an operation controller. The first irradiator irradiates a subject with light having a first wavelength. The second irradiator irradiates the subject with light having a second wavelength longer than the first wavelength. The incident light limiter defines a third wavelength shorter than the first wavelength as a reference, absorbs light having a wavelength shorter than the third wavelength, and transmits light having a wavelength longer than the third wavelength. The generator generates a first image on the basis of reflected light which enters from the subject through the incident light limiter when the subject is irradiated with the light having the first wavelength, and generates a second image on the basis of the reflected light which enters from the subject through the incident light limiter when the subject is irradiated with the light having the second wavelength. The detector detects the skin region on the basis of the first image and the second image. The operation controller performs a specified processing in response to a change in the detected skin region.

In the second embodiment of the present invention, the first image is generated on the basis of the reflected light which enters from the subject through the incident light limiting means when the subject is irradiated with the light having the first wavelength, and the second image is generated on the basis of the reflected light which enters from the subject through the incident light limiting means when the subject is irradiated with the light having the second wavelength. The skin region is detected on the basis of the first image and the second image, and the specified processing is performed in response to a change in the detected skin region.

According to embodiments of the present invention the spectral characteristic of the optical filter and the wavelength of the irradiation light can be optimized. Further, according to the present invention, the output of the irradiation light source can be suppressed.

### BRIEF DESCRIPTION OF DRAWINGS

FIG. 1 is a block diagram to show a constructive example of a detecting apparatus to which the present invention is applied.

FIG. 2 is a graph to show the reflective characteristics of a human skin.

FIG. 3 is a graph to show the spectral sensitivity characteristics of an imaging section.

FIG. 4 is a graph to show the spectral characteristics of external light.

FIG. 5 is a table to show a reflectance difference detection signal (relative value) S for various combinations of wavelengths lambda1, lambda2 (wavelength lambdacut 800 nm (10% or less change ranging from 800 nm to 880 nm)).

FIG. 6 is a table to show minimum necessary values of irradiance (relative value) I1 of light having a wavelength lambda1 for various combinations of a wavelength lambda1 and an absorption edge wavelength lambdacut, where lambda1 is necessary irradiance (relative value) and lambda2=940, 970 nm.

FIG. 7, including FIGS. 7A and 7B, is a table to show the fluctuation band of the reflectance difference detection signal (relative value) S for various combinations of the wavelength lambda1 and the absorption edge wavelength lambdacut when the ambient temperature under which the apparatus is used (skin signal fluctuation depending on temperature (%)), where lambda2=940 in FIG. 7A and lambda2=970 in FIG. 7B).

### DESCRIPTION OF EMBODIMENTS

Hereinafter, the best mode for carrying out the invention (hereinafter referred to as “embodiment”) will be described in detail with reference to the drawings.

### 1. Embodiment

(Constructive Example of Detecting Apparatus)

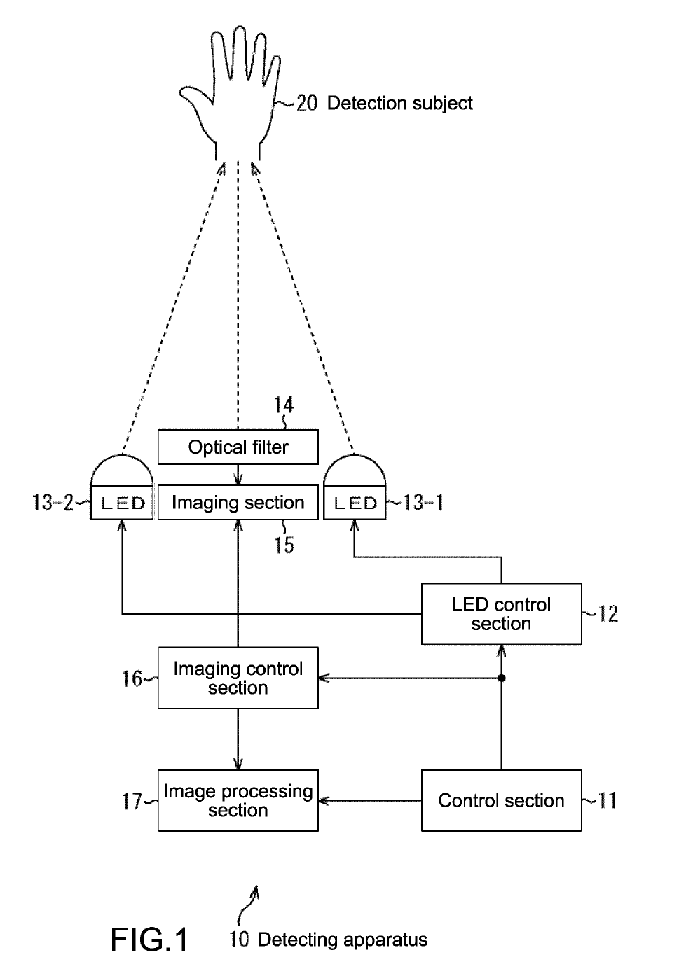

FIG. 1 shows a constructive example of a detecting apparatus of an embodiment of the present invention. This detecting apparatus 10 detects a skin region (for example, face, hand, and the like) of a human body of a detection subject 20 from a taken image. The detecting apparatus can prevent the effect of external light and can decrease the quantity of light of an irradiation light source by optimizing the optical characteristics of an optical filter and the wavelength of irradiation light.

The detecting apparatus 10 includes a control section 11, an LED control section 12,

LEDs 13-1 and 13-2, an optical filter 14, an imaging section 15, an imaging control section 16, and an image processing section 17.

The control section 11 supervises and controls the actions of the respective sections of the detecting apparatus 10. The LED control section 12 controls the timing of turning on and off the LEDs 13-1 and 13-2, and the output levels of the LEDs 13-1 and 13-2 according to the control given by the control section 11. The LED 13-1 emits light in which an emission spectrum has a half width at half maximum of about 50 nm and has a peak wavelength of lambda1 (hereinafter referred to as “light having a wavelength of lambda1”) according to the control given by the LED control section 12. The LED 13-2 emits light in which an emission spectrum has a half width at half maximum of about 50 nm and has a peak wavelength of lambda2 (hereinafter referred to as “light having a wavelength of lambda2”) according to the control given by the LED control section 12. In this regard, the value of the wavelength of lambda1 ranges from 800 nm to 1000 nm and the value of the wavelength of lambda2, which is longer than the wavelength of lambda1, ranges from 900 nm to 1100 nm, which will be described later in detail.

The optical filter 14 is provided in front of the imaging section 15 so as to limit light incident upon the imaging section 15. As for the optical characteristics of the optical filter 14, the optical filter 14 is adapted to absorb light having a wavelength shorter than a specified wavelength (hereinafter referred to as “absorption edge wavelength lambdacut”) and to transmit light having a wavelength longer than the absorption edge wavelength (cut. In this regard, the value of the absorption edge wavelength (cut will be also described later in detail.

The imaging section 15 includes a collective lens and an imaging element such as CCD or CMOS and receives light passing through the optical filter 14 (light reflected by a subject) according to the control given by the imaging control section 16 and generates an image. Here, an image generated when the LED 13-1 emits the light having the wavelength of lambda1 is assumed to be a first image and an image generated when the LED 13-2 emits the light having the wavelength of lambda2 is assumed to be a second image.

The imaging control section 16 controls the imaging timing and the gain of luminance amplification of the imaging section 15 according to the control given by the control section 11. Further, the imaging control section 16 outputs the first image and the second image generated by the imaging section 15 to the image processing section 17.

The imaging processing section 17 detects the skin region of the subject on the basis of the first image and the second image.

(Action of Detecting Device)

Firstly, the subject is irradiated with light having the wavelength of lambda1 by the LED 13-1. This irradiated light is reflected by the subject together with external light and has light having wavelengths shorter than the wavelength of lambdacut absorbed by the optical filter 14 and then is made incident on the imaging section 15. The imaging section 15 photoelectrically converts the incident light to generate the first image.

Next, the subject is irradiated with the light having the wavelength of lambda2 by the

LED 13-2. This irradiated light is reflected by the subject together with the external light and is made incident on the imaging section 15 through the optical filter 14. The imaging section 15 photoelectrically converts the incident light to generate the second image. The generated first and second images are supplied to the image processing section 17.

The image processing section 17 calculates a reflectance difference detection signal S=Y1-Y2, which is a difference between the luminance Y1 of a pixel corresponding to the first image and the luminance Y2 of a pixel corresponding to the second image, and compares the reflectance difference detection signal S with a specified threshold value to binarize the pixels and detects one region of binarized pixels as a skin region.

(Optical Characteristics of Optical Filter (absorption edge wavelength lambdacut) and Optimization of Wavelengths lambda1 and lambda2 of LEDs)

Firstly, there will be described an idea at the time of optimizing the optical characteristics (absorption edge wavelength (cut) of the optical filter and the wavelengths lambda1 and lambda2 of the LEDs.

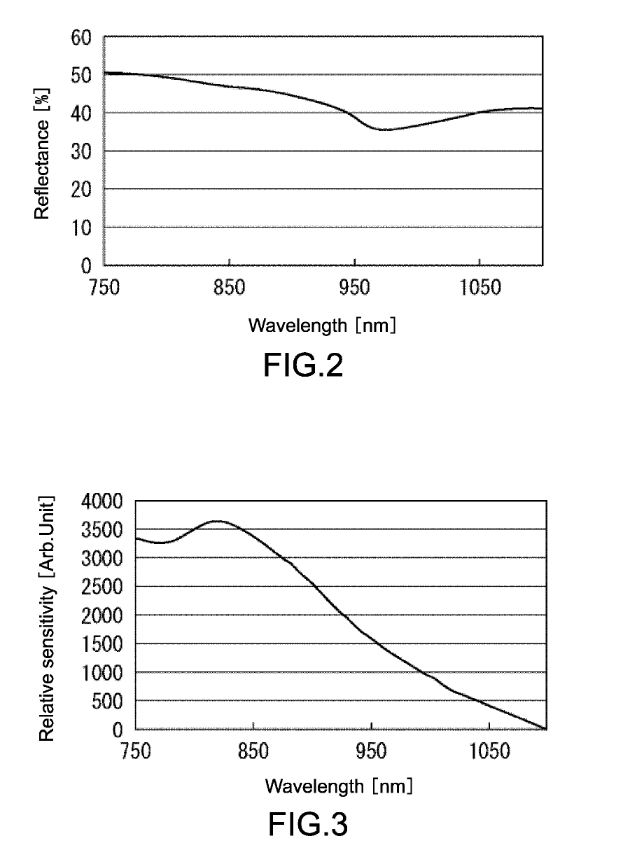

FIG. 2 shows the reflective characteristics assumed for the skin region of the human body which is a detection subject 20. As shown in the drawing, it is known that the skin region of the human body has a minimum value of reflectance for a wavelength close to 960 nm.

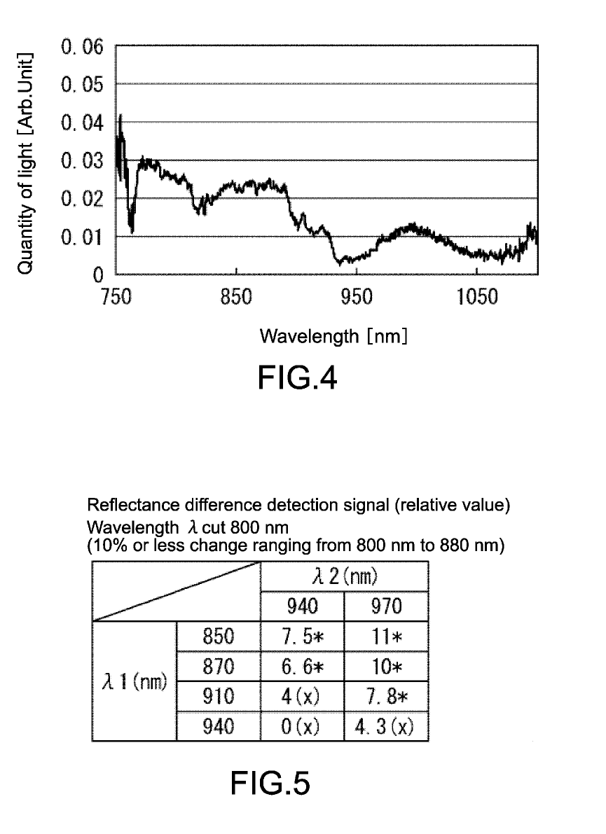

FIG. 3 shows the spectral sensitivity characteristic assumed for an imaging element built in the imaging section 15. FIG. 4 shows the spectral characteristic of external light that could be incident on the optical filter.

As described above, when the luminances of the pixels corresponding to the first image and the second image are assumed to be Y1 and Y2, the reflectance difference detection signal S is Y1-Y2. Since the reflectance for light having the wavelength lambda1 at the skin region is larger than the reflectance for light having the wavelength lambda2, the reflectance difference detection signal S becomes a positive value. However, the reflectance difference detection signal S needs to be larger by a certain value than noises that could be caused in the image processing section 17, so that the luminances Y1, Y2 of the pixels corresponding to the first image and the second image need to be large by a certain value.

When irradiances on a subject by the LEDs 13-1 and 13-2 are assumed to be I1 and 12, in order to make the luminances Y1, Y2 of the pixels corresponding to the first image and the second image large by a certain value as described above, the irradiances I1, I2 also need to be larger than a specified value.

Further, the luminances Y1, Y2 of the pixels corresponding to the first image and the second image large are also proportional to the gain of luminance amplification in the imaging section 15 and depend also on the wavelengths lambda1 and lambda2.

The gain of luminance amplification in the imaging section 15 needs to be set not to cause overexposure (saturation of luminance) at the time of imaging a subject under external light and has its upper limit determined depending on the optical characteristics (absorption edge wavelength lambdacut) of the optical filter 14.

In this way, the minimum necessary value and the reflectance difference detection signal S of the irradiance I1 of the LED 13-1 and the irradiance I2 of the LED 13-2 are determined from the wavelength lambda1 of the LED 13-1, the wavelength lambda2 of the LED 13-2, and the absorption edge wavelength lambdacut of the optical filter 14.

Further, when it is considered that each of the wavelength lambda1 of the LED 13-1 and the wavelength lambda2 of the LED 13-2 has a specified distribution characteristic and has a fluctuation band caused by a variation in the ambient temperature under which they are used, the optimal values of these wavelengths can be defined by the following conditional expression:

λ1+40≦λ2

λ1−70≦cut≦λ1−30 (1)

By selecting the wavelengths lambda1, lambda1 and the absorption edge wavelength lambdacut so as to satisfy the expression described above, the reflectance difference detection signal S can be kept at a value larger than noise and the irradiances I1, I2 of the LEDs 13-1, 13-2 can be kept at a minimum necessary value.

FIG. 5 shows a reflectance difference detection signal (relative value) S when a combination of the wavelengths lambda1, lambda2 is changed in a state where the absorption edge wavelength lambdacut is fixedly set at 800 nm under the assumption shown in FIG. 2 to FIG. 4. It is desirable that this reflectance difference detection signal (relative value) S is large (typically, larger than 5).

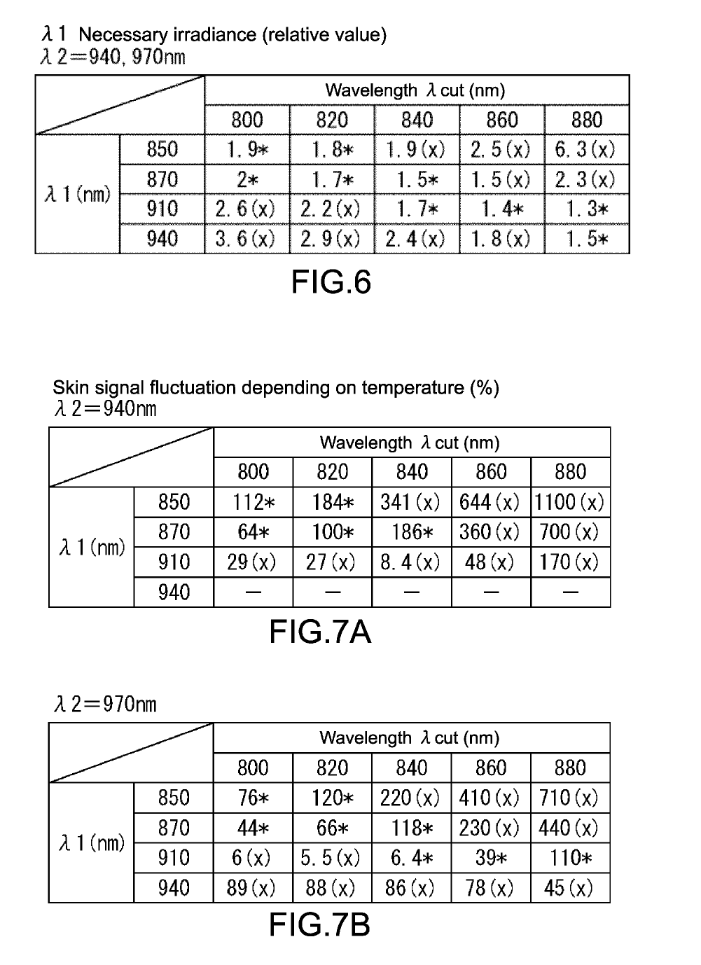

FIG. 6 shows minimum necessary values of irradiance (relative value) I1 of the light having the wavelength lambda1 by the LED 13-1 in a state where the wavelength lambda2 is set at 940 nm or 970 nm when a combination of the wavelength lambda1 and the absorption edge wavelength lambdacut is changed under the assumption shown in FIG. 2 to FIG. 4. In this regard, the minimum necessary values of irradiance (relative value) I2 of the light having the wavelength lambda2 by the LED 13-2 will be omitted in description because they correlate with the irradiance (relative value) I1. It is desirable that the minimum necessary value of this irradiance (relative value) I1 is small (typically, smaller than 2).

FIG. 7A shows the fluctuation band (percent for the reflectance difference detection signal (relative value) S under room temperature) of the reflectance difference detection signal (relative value) S for various combinations of the wavelength lambda1 and the absorption edge wavelength (cut when the ambient temperature when the apparatus is used is varied from 0 (C to 75 (C in a state where the wavelength lambda2 is fixedly set at 940 nm under the assumption shown in FIG. 2 to FIG. 4. It is desirable that this value is small (typically, smaller than 200%).

Similarly, FIG. 7B shows the fluctuation band (percent for the reflectance difference detection signal (relative value) S under room temperature of 25 (C) of the reflectance difference detection signal (relative value) S for various combinations of the wavelength lambda1 and the absorption edge wavelength lambdacut when the ambient temperature when the apparatus is used is varied from 0 (C to 75 (C in a state where the wavelength lambda2 is fixedly set at 970 nm under the assumption shown in FIG. 2 to FIG. 4. It is desirable that this value is small (typically, smaller than 200%).

In this regard, as for the results shown in FIG. 5 to FIG. 7, the desirable results are denoted by asterisks and the undesirable results (in which at least one of three kinds of result evaluation indexes shown in FIG. 5 and FIG. 7 is undesirable) are denoted by (x) marks.

As is clear from the results shown in FIG. 5 to FIG. 7, all combinations, which are denoted by the asterisks se being desirable in FIG. 5 to FIG. 7, satisfy the conditional expression (1) described above. On the other hand, there is no combinations, which are denoted by the (x) marks as being undesirable in FIG. 5 to FIG. 7 and satisfy the conditional expression (1).

Thus, the expression (1) described above can be considered to be nearly equal to a necessary and sufficient condition for three kinds of result evaluation indexes shown in FIG. 5 to FIG. 7 to be desirable.

Here, the reflective characteristics of the human skin has a little individual difference and there is a case where the spectral characteristic of the external light is different from the spectral characteristic shown in FIG. 2 or FIG. 4. However, it has been confirmed that even in that case, the conditional expression (1) described above becomes the necessary and sufficient condition for three kinds of result evaluation indexes shown in FIG. 5 to FIG. 7 to be desirable.

As described above, by setting the wavelength lambda1 of the LED 13-1, the wavelength lambda2 of the LED 13-2, and the absorption edge wavelength lambdacut of the optical filter 14 to satisfy the conditional expression (1), the irradiances of the LEDs 13-1, 13-2 can be decreased to a necessary and minimum value.

In the meantime, as for a general optical filter, a filter having a thin film structure formed on a substrate or a filter made of a resin plate formed by mixing materials capable of absorbing light is used. However, the structure and the materials of the optical filter 14 used for the present embodiment are not limited to these, that is, any structure and materials can be used if the optical filter 14 has the function of interrupting light having a specified range of wavelength so as to satisfy the conditional requirements described above.

For example, the optical filter 14 may be formed as a thin film on the surface of an optical component such as lens included in the imaging section 15. Further, for example, when a minor is included in a path from the subject to the imaging section 15, the optical filter 14 may be formed as a thin film on the surface of the mirror.

Further, the optical filter 14 may be included in the imaging section 15 as a camera unit or contrarily may be separated from the camera unit.

The function of interrupting light having a specified range of wavelength that the optical filter 14 needs to have can be realized by laminating a plurality of materials on a thin film to reflect or absorb light having a certain range of wavelength, but other method may be used. For example, it is also possible to use resin made by mixing materials absorbing light having a certain range of wavelength. Alternatively, it is also possible to select an imaging element in such a way that the spectral sensitivity of the imaging element tends to be low in a wavelength band cut by the optical filter 14. Furthermore, it is also possible to combine a plurality of the methods described above.

A detecting apparatus to which the present invention is applied can be built in an arbitrary electronic apparatus such as a television receiver. In the electronic apparatus, a specified processing can be performed in response to the motion of a hand or the like of the detected subject.

Embodiment of the present invention are not limited to the embodiment described above but can be variously modified without departing from the gist of the present invention.

The present application contains subject matter related to that disclosed in Japanese

Priority Patent Application JP 2010-018287 filed in the Japan Patent Office on Jan. 29, 2010, and Japanese Priority Patent Application JP 2010-158867 filed in the Japan Patent Office on Jul. 13, 2010, the entire content of which is hereby incorporated by reference.

### REFERENCE SIGNS LIST

10 detecting apparatus

11 control section

12 led control section

13 led

14 optical filter

15 imaging section

16 imaging control section

17 image processing section

1. An image processing apparatus to detect a skin region representing a human skin from an image, the apparatus comprising:
a first irradiation means for irradiating a subject with light having a first wavelength;
a second irradiation means for irradiating the subject with light having a second wavelength longer than the first wavelength;
an incident light limiting means for defining a third wavelength shorter than the first wavelength as a reference, for absorbing light having a wavelength shorter than the third wavelength, and for transmitting light having a wavelength longer than the third wavelength;
a generating means for generating a first image on the basis of reflected light which enters from the subject through the incident light limiting means when the subject is irradiated with the light having the first wavelength and for generating a second image on the basis of the reflected light which enters from the subject through the incident light limiting means when the subject is irradiated with the light having the second wavelength; and
a detecting means for detecting the skin region on the basis of the first image and the second image.

2. The image processing apparatus according to claim 1, wherein the first wavelength lambda1, the second wavelength lambda2, and the third wavelength lambdacut satisfy the following expressions,
λ1−70 nm≦λcut≦λ1−30 nm
λ1+40 nm<λ2

3. The image processing apparatus according to claim 2, wherein the first wavelength lambda1 and the second wavelength lambda2 satisfy the following expressions,
800 nm<λ1<1000 nm
900 nm<λ2<1100 nm

4. An image processing method for an image processing apparatus including
a first irradiation means for irradiating a subject with light having a first wavelength,
a second irradiation means for irradiating the subject with light having
a second wavelength longer than the first wavelength,
an incident light limiting means for defining a third wavelength shorter than the first wavelength as a reference, for absorbing light having a wavelength shorter than the third wavelength, and for transmitting light having a wavelength longer than the third wavelength,
a generating means for generating an image on the basis of reflected light which enters from the subject, and
a detecting means for detecting the skin region on the basis of the generated images, the image processing method comprising:
a first irradiation step of irradiating the subject with the light having the first wavelength by the first irradiation means;
a first generating step of generating a first image by the generating means on the basis of the reflected light that enters from the subject through the incident light limiting means when the subject is irradiated with the light having the first wavelength;
a second irradiation step of irradiating the subject with the light having the second wavelength by the second irradiation means;
a second generating step of generating a second image by the generating means on the basis of the reflected light that enters from the subject through the incident light limiting means when the subject is irradiated with the light having the second wavelength; and
a detection step of detecting the skin region on the basis of the first image and the second image by the detecting means.

5. An electronic apparatus comprising:
a first irradiation means for irradiating a subject with light having a first wavelength;
a second irradiation means for irradiating the subject with light having a second wavelength longer than the first wavelength;
an incident light limiting means for defining a third wavelength shorter than the first wavelength as a reference, for absorbing light having a wavelength shorter than the third wavelength, and for transmitting light having a wavelength longer than the third wavelength;
a generating means for generating a first image on the basis of reflected light which enters from the subject through the incident light limiting means when the subject is irradiated with the light having the first wavelength and for generating a second image on the basis of the reflected light which enters from the subject through the incident light limiting means when the subject is irradiated with the light having the second wavelength;
a detecting means for detecting the skin region on the basis of the first image and the second image; and
an operation controlling means for performing a specified processing in response to a change in the detected skin region.

6. An image processing apparatus to detect a skin region representing a human skin from an image, the apparatus comprising:
a first irradiator to irradiate a subject with light having a first wavelength;
a second irradiator to irradiate the subject with light having a second wavelength longer than the first wavelength;
an incident light limiter to define a third wavelength shorter than the first wavelength as a reference, to absorb light having a wavelength shorter than the third wavelength, and to transmit light having a wavelength longer than the third wavelength;
a generator to generate a first image on the basis of reflected light which enters from the subject through the incident light limiter when the subject is irradiated with the light having the first wavelength and to generate a second image on the basis of the reflected light which enters from the subject through the incident light limiter when the subject is irradiated with the light having the second wavelength; and
a detector to detect the skin region on the basis of the first image and the second image.

7. An electronic apparatus comprising:
a first irradiator to irradiate a subject with light having a first wavelength;
a second irradiator to irradiate the subject with light having a second wavelength longer than the first wavelength;
an incident light limiter to define a third wavelength shorter than the first wavelength as a reference, to absorb light having a wavelength shorter than the third wavelength, and to transmit light having a wavelength longer than the third wavelength;
a generator to generate a first image on the basis of reflected light which enters from the subject through the incident light limiter when the subject is irradiated with the light having the first wavelength and to generate a second image on the basis of the reflected light which enters from the subject through the incident light limiter when the subject is irradiated with the light having the second wavelength;
a detector to detect the skin region on the basis of the first image and the second image; and
an operation controller to perform a specified processing in response to a change in the detected skin region.
